(19) United States
(12) Patent Application Publication
(10) Pub. No.: US 2019/0124978 A1
(43) Pub. Date: May 2, 2019

(54) ELECTRONIC CIGARETTE, ATOMIZER AND ATOMIZING DEVICE THEREOF

(71) Applicant: Qiuming LIU, Guangdong (CN)

(72) Inventor: Qiuming LIU, Guangdong (CN)

(21) Appl. No.: 14/360,738

(22) PCT Filed: Jul. 31, 2013
(86) PCT No.: PCT/CN2013/080476

§ 371 Date: Jul. 30, 2014

(30) Foreign Application Priority Data
Jul. 24, 2013 (CN) 201320444180.3

(51) Int. Cl. A24F 47/00; H05B 3/42

(52) U.S. Cl. CPC A24F 47/008; H05B 3/42

(57) ABSTRACT

An electronic cigarette, an atomizer and an atomizing device thereof are provided according to the present application. A second liquid guide cord is arranged parallel to a first liquid guide cord in mounting holes and in contact with a heating wire, which improves the liquid supply capacity of the device, thus the amount of smoke may be effectively increased as the heating value of the heating wire increases, the risk of burning cotton may be reduced, and a better flavor and a better user experience may be provided.

The present application claims the benefit of priority to Chinese Patent Application No. 201320444180.3 titled “ELECTRONIC CIGARETTE, ATOMIZER AND ATOMIZING DEVICE THEREOF”, filed with the Chinese State Intellectual Property Office on Jul. 24, 2013, the entire disclosure of which is incorporated herein by reference.

### TECHNICAL FIELD

The present application relates to the technical field of electronic cigarettes, and particularly to an electronic cigarette, an atomizer and an atomizing device thereof.

### BACKGROUND

A conventional structure of a main heating component of an atomizer of an electronic cigarette is shown in FIG. 1 and FIG. 2. A heating wire 11 is coiled around a fiberglass wire 12, and two ends of the fiberglass wire 12 are each connected with a respective electronic wire 13, then the fiberglass wire 12 is passed through mounting holes in an inner fiberglass pipe 141, and an outer fiberglass pipe 142 is arranged outside the inner fiberglass pipe 141 (to facilitate the fiberglass wire 12 to pass through the inner fiberglass pipe 141, the mounting holes in the inner fiberglass pipe 141 generally has a size larger than that of the fiberglass wire 12, and an opening left on the inner fiberglass pipe 141 after the fiberglass wire 12 is passed through may be covered by the outer fiberglass pipe 142 arranged outside the inner fiberglass pipe 141). The heating wire 11 is used to provide a heating value, the fiberglass wire 12 is used to guide liquid, and the inner fiberglass pipe 141 is used to provide a smooth air passage.

Customers normally require that the electronic cigarette can generate a large amount of smoke, and to fulfill the requirement, the heating value is increased by reducing a resistance value or a diameter of the heating wire 11. However, a liquid guiding rate of the fiberglass wire 12 does not increased as the heating value increases, and in this situation, a temperature of the heating wire assembly may be increased, and when the temperature reaches a certain degree, the fiberglass assembly may be metamorphosed at the high temperature, and the liquid may be burn at the high temperature, emitting a burning smell.

In view of this, a technical problem to be solved presently by those skilled in the art is to effectively increase the amount of smoke, reduce the risk of burning cotton, so as to provide a better flavor and a better user experience.

### SUMMARY

In view of this, an electronic cigarette, an atomizer and an atomizing device thereof are provided according to the present application, which may effectively increase the amount of smoke, reduce the risk of burning cotton, and provide a better flavor and a better user experience.

To achieve the above objects, the following technical solutions are provided according to the present application.

An atomizing device includes a heating wire assembly and an air pipe, the heating wire assembly wherein includes a heating wire, a first liquid guide cord and an electronic wire, the air pipe has mounting holes for containing the heating wire assembly, and the atomizing device further includes a second liquid guide cord arranged parallel to the first liquid guide cord in the mounting holes and in contact with the heating wire.

Preferably, the atomizing device includes at least one heating assembly, wherein each heating assembly consists of the heating wire assembly and the second liquid guide cord.

Preferably, the first liquid guide cord and the second liquid guide cord are closely abutting with each other.

Preferably, the atomizing device also includes an auxiliary pipe arranged outside the air pipe and configured to abut against the heating wire assembly or the second liquid guide cord.

Preferably, a mounting notch is provided on a pipe wall at one side of the air pipe in a circumferential direction, and two ends of the mounting notch are communicated with the mounting holes at two sides of the air pipe respectively.

Preferably, a section of the mounting notch in an axial direction of the air pipe is of a trapezoidal shape, and a width of the mounting notch decreases gradually in a direction from an outer wall to an inner wall of the air pipe.

An atomizer of an electronic cigarette includes the above atomizing device.

An electronic cigarette includes a battery rod and an atomizer connected to the battery rod, wherein the atomizer is the above atomizer.

According to the above technical solutions, the atomizing device according to the present application includes the second liquid guide cord arranged parallel to the first liquid guide cord in the mounting holes and in contact with the heating wire, which improves the liquid supply capacity of the device, thus the amount of smoke may be effectively increased as the heating value of the heating wire increases, the risk of burning cotton may be reduced, and a better flavor and a better user experience may be provided.

### BRIEF DESCRIPTION OF THE DRAWINGS

In order to more clearly illustrate the embodiments of the present application or the technical solution in the prior art, drawings referred to describe the embodiments or the prior art will be briefly described hereinafter. Apparently, the drawings in the following description are only several embodiments of the present application, and for those skilled in the art, other drawings may be obtained based on these drawings without any creative work.

FIG. 1 is a schematic view showing the structure of a main heating component of an atomizer of an electronic cigarette in the conventional technology;

FIG. 2 is a sectional view of the main heating component of the atomizer of the electronic cigarette in the conventional technology;

FIG. 3 is a schematic view showing the structure of an atomizing device according to a first embodiment of the present application;

FIG. 4 is an exploded view of the atomizing device according to the first embodiment of the present application;

FIG. 5 is a schematic view showing the structure of an atomizing device according to a second embodiment of the present application;

FIG. 6 is an exploded view of the atomizing device according to the second embodiment of the present application;

FIG. 7 is a schematic view showing the structure of an atomizing device according to a third embodiment of the present application; and

FIG. 8 is an exploded view of the atomizing device according to the third embodiment of the present application.

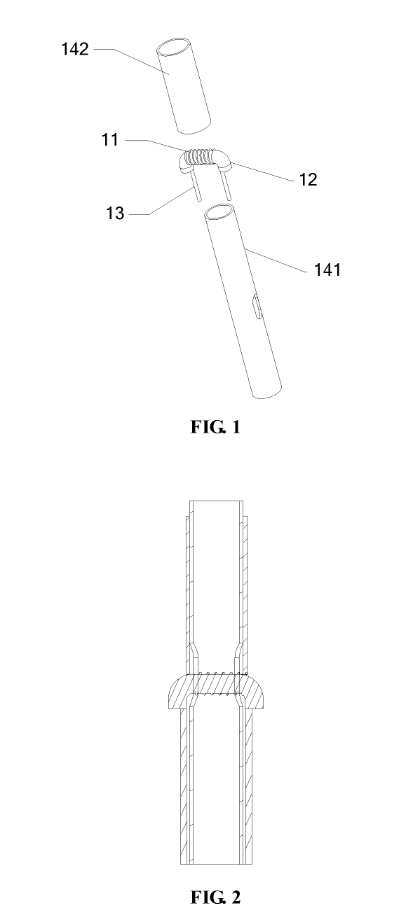

### REFERENCE NUMERALS IN FIG. 1 AND FIG. 2

| | | | |
|---|---|---|---|
| 11 | heating wire, | 12 | fiberglass wire, |
| 13 | electronic wire, | 141 | inner fiberglass pipe, and |
| 142 | outer fiberglass pipe; | | |

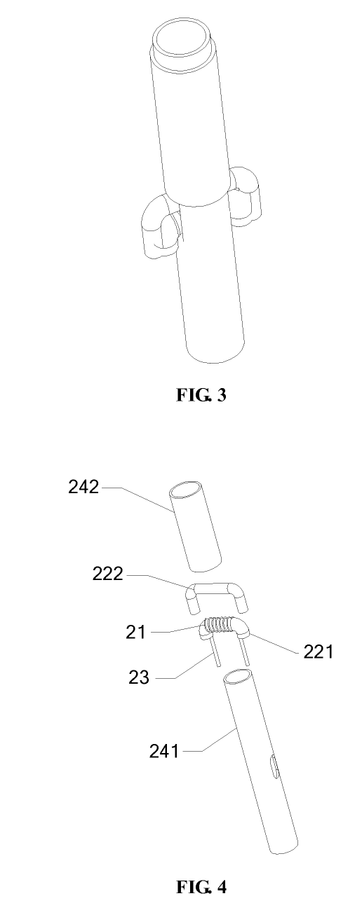

### REFERENCE NUMERALS IN FIG. 3 AND FIG. 4

| | | | |
|---|---|---|---|
| 21 | heating wire, | 221 | first fiberglass wire, |
| 222 | second fiberglass wire, | 23 | electronic wire, |
| 241 | inner fiberglass pipe, and | 242 | outer fiberglass pipe; |

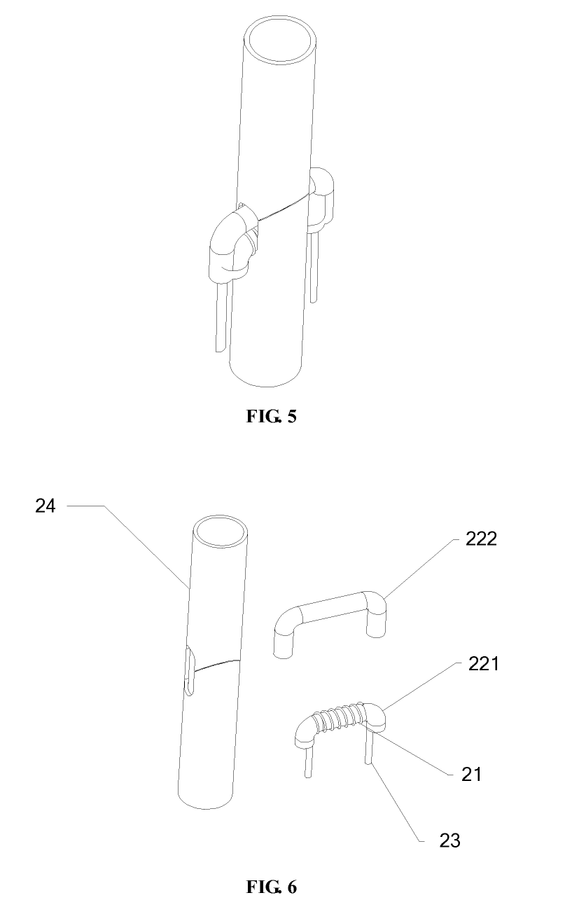

### REFERENCE NUMERALS IN FIG. 5 AND FIG. 6

| | | | |
|---|---|---|---|
| 21 | heating wire, | 221 | first fiberglass wire, |
| 222 | second fiberglass wire, | 23 | electronic wire, and |
| 24 | fiberglass pipe; and | | |

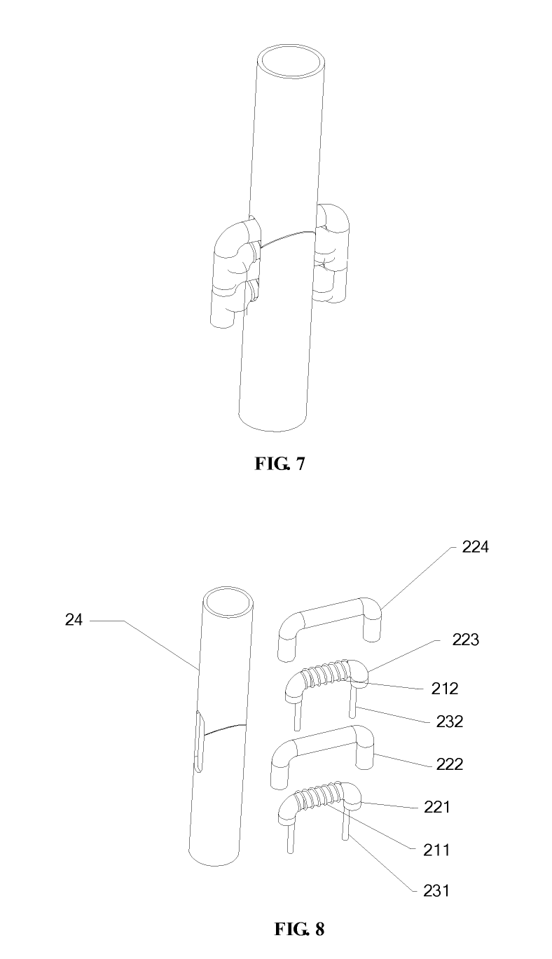

### REFERENCE NUMERALS IN FIG. 7 AND FIG. 8

| | | | |
|---|---|---|---|
| 211 | first heating wire, | 212 | second heating wire, |
| 221 | first fiberglass wire, | 222 | second fiberglass wire, |
| 223 | third fiberglass wire, | 224 | fourth fiberglass wire, |
| 231 | first electronic wire, | 232 | second electronic wire, and |
| 24 | fiberglass pipe. | | |

### DETAILED DESCRIPTION

An electronic cigarette, an atomizer and an atomizing device thereof are provided according to the present application, which may effectively increase the amount of smoke, reduce the risk of burning cotton, and provide a better flavor and a better user experience.

The technical solutions in the embodiments of the present application will be described clearly and completely hereinafter in conjunction with the drawings in the embodiments of the present application. Apparently, the described embodiments are only a part of the embodiments of the present application, rather than all embodiments. Based on the embodiments in the present application, all of other embodiments, made by the person skilled in the art without any creative efforts, fall into the protection scope of the present application.

Reference is made to FIGS. 1 to 8, wherein FIG. 1 is a schematic view showing the structure of a main heating component of an atomizer of an electronic cigarette in the conventional technology; FIG. 2 is a sectional view of the main heating component of the atomizer of the electronic cigarette in the conventional technology; FIG. 3 is a schematic view showing the structure of a heating component of an atomizer according to a first embodiment of the present application; FIG. 4 is an exploded view of the heating component of the atomizer according to the first embodiment of the present application; FIG. 5 is a schematic view showing the structure of a heating component of an atomizer according to a second embodiment of the present application; FIG. 6 is an exploded view of the heating component of the atomizer according to the second embodiment of the present application; FIG. 7 is a schematic view showing the structure of a heating component of an atomizer according to a third embodiment of the present application; and FIG. 8 is an exploded view of the heating component of the atomizer according to the third embodiment of the present application.

The atomizing device according to the present application includes a heating wire assembly and an air pipe, the heating wire assembly includes a heating wire, a first liquid guide cord and an electronic wire, and the air pipe has mounting holes for containing the heating wire assembly. A main improvement of the atomizing device is that, the atomizing device further includes a second liquid guide cord arranged parallel to the first liquid guide cord in the mounting holes and in contact with the heating wire.

Compared with the conventional technology, the atomizing device according to the present application includes the second liquid guide cord arranged parallel to the first liquid guide cord in the mounting holes and in contact with the heating wire, which improves the liquid supply capacity of the device, thus the amount of smoke may be effectively increased as the heating value of the heating wire increases, the risk of burning cotton may be reduced, and a better flavor and a better user experience may be provided.

Preferably, the first liquid guide cord and the second liquid guide cord are closely abutting with each other to better transfer heat. The parallel connection by direct overlapping the liquid guide cords may fully exert the heat generation effect of the heating wire, and this manner, compared with the existing structure, requires only a minor adjustment and is easy to realize.

The atomizing device according to the present application further includes an auxiliary pipe arranged outside the air pipe and configured to abut against the heating wire assembly or the second liquid guide cord and to cover an opening left on the air pipe after the fiberglass wire is passed through. Preferably, the liquid guide cord is made of fiberglass wire, and both the air pipe and the auxiliary pipe are made of fiberglass pipe. Referring to FIG. 3 and FIG. 4, in the first embodiment, a heating wire 21 is coiled around a first fiberglass wire 221 (i.e., the first liquid guide cord), two ends of the first fiberglass wire 221 are each connected with a respective electronic wire 23, and the first fiberglass wire 221 is passed through the mounting holes in an inner fiberglass pipe 241 (i.e., the air pipe). A second fiberglass wire 222 (i.e., the second liquid guide cord) is further provided on the first fiberglass wire 221 to be in contact with the heating wire 21, and an outer fiberglass pipe 242 (i.e., the auxiliary pipe) is arranged outside the inner fiberglass pipe 241.

In order to further optimize the above technical solutions, a mounting notch is provided on a pipe wall at one side of the air pipe in a circumferential direction, and two ends of the mounting notch are communicated with the mounting holes at two sides of the air pipe respectively, and the structure of the mounting notch is shown in FIGS. 5 to 8. During the assembly, the fiberglass wire may be directly pressed into the air pipe through the notch, thereby reducing the assembling difficulty. Preferably, since there is no need to provide an additional fiberglass pipe outside the air pipe, the size of the mounting holes shall be arranged to match with the overall assembly size of the heating assembly, so as to minimize the opening left on the air pipe after the assembly is completed.

Referring to FIG. 5 and FIG. 6, in a second embodiment, a fiberglass pipe 24 (i.e., the air pipe) is cut open while being punched, a heating wire 21 is coiled around a first fiberglass wire 221 (i.e., the first liquid guide cord), two ends of the first fiberglass wire 221 are each connected with a respective electronic wire 23, and the first fiberglass wire 221 is pressed into the mounting holes at two sides of the fiberglass pipe 24 via the cut side of the fiberglass pipe 24, and a second fiberglass wire 222 (i.e., the second liquid guide cord) is further provided on the first fiberglass wire 221 to be in contact with the heating wire 21.

In order to further increase the amount of smoke, the atomizing device according to the present application may include multiple heating assemblies each of which includes a heating wire assembly and a second liquid guide cord.

According to a third embodiment, the atomizing device includes two heating assemblies (i.e., including two heating wires and four fiberglass wires), and the structure of the atomizing device is shown in FIG. 7 and FIG. 8. A fiberglass pipe 24 (i.e., the air pipe) is cut open while being punched, a first heating wire 211 is coiled around a first fiberglass wire 221 (i.e., the first liquid guide cord), two ends of the first fiberglass wire 221 are each connected with a respective first electronic wire 231, and the first fiberglass wire 221 is pressed into the mounting holes at two sides of the fiberglass pipe 24 via the cut side of the fiberglass pipe 24, and a second fiberglass wire 222 (i.e., the second liquid guide cord) is further provided on the first fiberglass wire 221 to be in contact with the first heating wire 211. A second heating wire 212 is coiled around a third fiberglass wire 223, and the third fiberglass wire 223 is further provided on the second fiberglass wire 222, and a fourth fiberglass wire 224 is provided on the third fiberglass wire 223.

Apparently, the above embodiments are merely three preferred embodiments, and the structure of the present application shall not be limited to this. For those skilled in the art, a number of each of the heating wire and the fiberglass wire and the fitting manner therebetween may be adjusted appropriately according to actual demands, which will not be described herein.

In order to further optimize the above technical solutions, a section of the mounting notch in an axial direction of the air pipe is of a trapezoidal shape, and a width of the mounting notch decreases gradually in a direction from an outer wall to an inner wall of the air pipe, so as to facilitate pressing the fiberglass wire into the air pipe.

An atomizer of an electronic cigarette is further provided according to an embodiment of the present application, and a main improvement is that, the atomizer has the above atomizing device.

An electronic cigarette is further provided according to an embodiment of the present application, which includes a battery rod and an atomizer connected to the battery rod, and a main improvement of the electronic cigarette is that, the atomizer is the above atomizer. The electronic cigarette includes the second liquid guide cord arranged parallel to the first liquid guide cord in the mounting holes and in contact with the heating wire, which improves the liquid supply capacity of the device, thus the amount of smoke may be effectively increased as the heating value of the heating wire increases, the risk of burning cotton may be reduced, and a better flavor and a better user experience may be provided.

The above embodiments are described in a progressive manner. Each of the embodiments is mainly focused on describing its differences from other embodiments, and references may be made among these embodiments with respect to the same or similar portions among these embodiments.

Based on the above description of the disclosed embodiments, the person skilled in the art is capable of carrying out or using the present application. It is obvious for the person skilled in the art to make many modifications to these embodiments. The general principle defined herein may be applied to other embodiments without departing from the spirit or scope of the present application. Therefore, the present application is not limited to the embodiments illustrated herein, but should be defined by the broadest scope consistent with the principle and novel features disclosed herein.

1. An atomizing device, comprising a heating wire assembly and an air pipe, the heating wire assembly comprising a heating wire, a first liquid guide cord and an electronic wire, the air pipe having mounting holes for containing the heating wire assembly, wherein the atomizing device further comprises a second liquid guide cord arranged parallel to the first liquid guide cord in the mounting holes and in contact with the heating wire.

2. The atomizing device according to claim 1, comprising at least one heating assembly, wherein each heating assembly consists of the heating wire assembly and the second liquid guide cord.

3. The atomizing device according to claim 2, wherein the first liquid guide cord and the second liquid guide cord are closely abutting with each other.

4. The atomizing device according to claim 1, comprising an auxiliary pipe arranged outside the air pipe and configured to abut against the heating wire assembly or the second liquid guide cord.

5. The atomizing device according to claim 1, wherein a mounting notch is provided on a pipe wall at one side of the air pipe in a circumferential direction, and two ends of the mounting notch are communicated with the mounting holes at two sides of the air pipe respectively.

6. The atomizing device according to claim 5, wherein a section of the mounting notch in an axial direction of the air pipe is of a trapezoidal shape, and a width of the mounting notch decreases gradually in a direction from an outer wall to an inner wall of the air pipe.

7. An atomizer of an electronic cigarette, comprising an atomizing device, wherein the atomizing device comprises a heating wire assembly and an air pipe, the heating wire assembly comprises a heating wire, a first liquid guide cord and an electronic wire, the air pipe has mounting holes for containing the heating wire assembly, and the atomizing device further comprises a second liquid guide cord arranged parallel to the first liquid guide cord in the mounting holes and in contact with the heating wire.

8. An electronic cigarette, comprising a battery rod and an atomizer connected to the battery rod, wherein the atomizer comprises an atomizing device, the atomizing device comprises a heating wire assembly and an air pipe, the heating wire assembly comprises a heating wire, a first liquid guide cord and an electronic wire, the air pipe has mounting holes for containing the heating wire assembly, and the atomizing device further comprises a second liquid guide cord arranged parallel to the first liquid guide cord in the mounting holes and in contact with the heating wire.

9. The atomizing device according to claim 2, wherein a mounting notch is provided on a pipe wall at one side of the air pipe in a circumferential direction, and two ends of the mounting notch are communicated with the mounting holes at two sides of the air pipe respectively.

10. The atomizing device according to claim 3, wherein a mounting notch is provided on a pipe wall at one side of the air pipe in a circumferential direction, and two ends of the mounting notch are communicated with the mounting holes at two sides of the air pipe respectively.

11. The atomizing device according to claim 4, wherein a mounting notch is provided on a pipe wall at one side of the air pipe in a circumferential direction, and two ends of the mounting notch are communicated with the mounting holes at two sides of the air pipe respectively.

12. The atomizer of the electronic cigarette according to claim 7, wherein the atomizing device comprises at least one heating assembly, and each heating assembly consists of the heating wire assembly and the second liquid guide cord.

13. The atomizer of the electronic cigarette according to claim 12, wherein the first liquid guide cord and the second liquid guide cord are closely abutting with each other.

14. The atomizer of the electronic cigarette according to claim 7, wherein the atomizing device comprises an auxiliary pipe arranged outside the air pipe and configured to abut against the heating wire assembly or the second liquid guide cord.

15. The atomizer of the electronic cigarette according to claim 7, wherein a mounting notch is provided on a pipe wall at one side of the air pipe in a circumferential direction, and two ends of the mounting notch are communicated with the mounting holes at two sides of the air pipe respectively.

16. The atomizer of the electronic cigarette according to claim 15, wherein a section of the mounting notch in an axial direction of the air pipe is of a trapezoidal shape, and a width of the mounting notch decreases gradually in a direction from an outer wall to an inner wall of the air pipe.

17. The electronic cigarette according to claim 8, wherein the atomizing device comprises at least one heating assembly, and each heating assembly consists of the heating wire assembly and the second liquid guide cord.

18. The electronic cigarette according to claim 17, wherein the first liquid guide cord and the second liquid guide cord are closely abutting with each other.

19. The electronic cigarette according to claim 8, wherein the atomizing device comprises an auxiliary pipe arranged outside the air pipe and configured to abut against the heating wire assembly or the second liquid guide cord.

20. The electronic cigarette according to claim 8, wherein a mounting notch is provided on a pipe wall at one side of the air pipe in a circumferential direction, and two ends of the mounting notch are communicated with the mounting holes at two sides of the air pipe respectively.
